(19) United States
(12) Patent Application Publication
(10) Pub. No.: US 2021/0406471 A1
(43) Pub. Date: Dec. 30, 2021

(54) METHODS AND SYSTEMS FOR ABRIDGING ARRAYS OF SYMBOLS

(71) Applicant: SEMINAL LTD., Ramat HaSharot (IL)

(72) Inventors: Jose Roberto KULLOK, Efrat (IL); Saul KULLOK, Efrat (IL)

(21) Appl. No.: 17/356,996

(22) Filed: Jun. 24, 2021

Related U.S. Application Data
(60) Provisional application No. 63/044,147, filed on Jun. 25, 2020.

(51) Int. Cl. G06F 40/289; G06F 40/268; G06F 40/284; G06F 40/211; G06F 16/35; G10L 13/08

(52) U.S. Cl. CPC G06F 40/289; G06F 40/268; G10L 13/08; G06F 40/211; G06F 16/353; G06F 40/284

(57) ABSTRACT

Described herein are embodiments for computer generating abridgments of texts based on matching rules applied to letter matching groups formed from sentences a first Text. The embodiments may also add prompting or alerting of comprehension and facilitate learning and memorization of the first Text by reading at least one of the separate shorter texts obtained from correlating pairs of previously discriminated contiguous sentences, by not altering the semantics, syntax and grammar of the first Text. Embodiments may prompt reading comprehension and facilitate learning and memorization of information by inducing a sensorial stimulation to the reader, based on sensorial modulation of specific typographic parameters of specific letters and by restructuring in novel ways the visual layout of the separate shorter abridged texts.

### BACKGROUND

Written documents can be an effective method of conveying information. However, the time required to read such written documents can be prohibitive, whether due to their length or due to the limited time available to read in modern society. Further, the content of the written document may require repeated readings in order to understand the contents. In some cases, the difficulty in understanding the content of the written document may be inherent to the content itself.

In general, a number of techniques have been proposed to optimize electronic text reading. They include, for instance, techniques known as Rapid Serial Visual Presentation (RSVP), where text is displayed one word at a time at the same screen location, techniques that emphasize eye movement destinations by arranging or flickering the characters, and techniques based on typographic cuing and techniques that use hard-to-read fonts.

Other approaches include providing a summary of text, which contributes to its comprehension. One way to solve the problem of long texts is to summarize or abridge the text. This can be performed by a person, who can create an abridgement by rewriting the text in a shorter version. In order to shorten the text while retaining the meaning, the person must decide which information is necessary to understand the document. However, the necessary information is subject to the interpretation of the abridger. And people often rewrite the text to convey its meaning as they understand it, which can alter the content. While computers can be used to analyze text, computers typically struggle to interpret meaning. Because the computer cannot determine the full meaning of the document, the computer cannot determine which text can be removed to shorten the text.

### BRIEF SUMMARY

Provided herein are a system, apparatus, article of manufacture, method and/or computer program product embodiments, and/or combinations and sub-combinations thereof, for creating one or more computer-generated abridgements of a written document that convey the same information.

Some embodiments operate by abridging a text into a new second text and a new third text by adding each sentence in the text that satisfies at least one alphabetical matching rule with each adjacent sentence to the new second text and adding each sentence in the text that fails to satisfy the alphabetical matching rules with at least one adjacent sentence, to the new third text, then adding each sentence in the new second text that satisfies at least one alphabetical matching rule with each adjacent sentence to a new fourth text and adding each sentence in the new second text that fails to satisfy the alphabetical matching rules with at least one adjacent sentence to the third text, setting the new shorter second text equal to the fourth text, and repeating the steps of adding sentences to the new third text from the new fourth text and so on until the step of adding sentences from the new shorter second text to the new larger third text fails to add a sentence to this new larger third text, then, if the first sentence or last sentence from the text is missing from the new shorter second text or the new larger third text, adding the missing sentences to those texts.

Further embodiments, features, and advantages of the present disclosure, as well as the structure and operation of the various embodiments of the present disclosure, are described in detail below with reference to the accompanying drawings.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the art(s) to make and use the embodiments.

FIG. 1 illustrates a block diagram of a computing environment for creating a computer-generated abridgement of a text into one or more new texts, according to some embodiments.

FIG. 2 is a flow chart illustrating a method for creating a computer-generated abridgement of a text into one or more new texts, according to some embodiments.

FIG. 3A illustrates an example of a portion of a text that can be abridged, according to some embodiments.

FIG. 3B illustrates an example of a horizontal word group, according to some embodiments.

FIG. 4 illustrates an example of a portion of a text that can be abridged, according to some embodiments.

FIG. 5 illustrates an example of a text abridgement, according to some embodiments.

FIG. 6 illustrates a block diagram of a general-purpose computer that may be used to perform various aspects of the present disclosure, according to some embodiments.

FIG. 7 illustrates a block diagram of an application for abridging text from a URL, according to some embodiments.

FIG. 8 illustrates a block diagram of an application for abridging text from a file, according to some embodiments.

FIG. 9 illustrates a block diagram of an application for abridging copied text, according to some embodiments.

FIG. 10 illustrates a block diagram of an application for viewing, reading and interacting with abridged text, according to some embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, article of manufacture, method and/or computer program product embodiments, and/or combinations and sub-combinations thereof, for creating one or more computer-generated abridgements of a written document, where these one or more computer-generated abridgements of a novel visual layout convey the same information and do not change the order of sentences in the resulting documents.

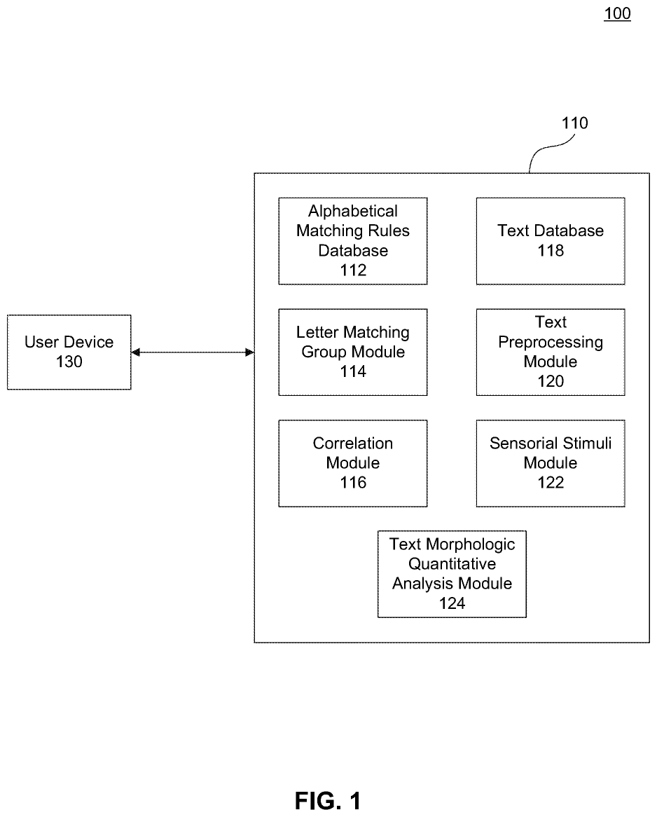

FIG. 1 depicts a block diagram 100 of an abridging system 110 and a user device 130. The abridging system 110 is made up of an alphabetical matching rules database 112, a letter matching group module 114, a correlation module 116, a text database 118, a text preprocessing module 120, a sensorial stimuli module 122 and a text morphologic quantitative analysis module 124.

A user may access the abridging system 110 through the user device 130, which may connect to the abridging system 110 through a network, the internet, the cloud, or other such communications interfaces. A user may provide a text from the user device 130, from an external source such as the internet, or may access a text stored in text database 118. The text provided by the user may be stored in text database 118.

The user may cause the abridging system 110 to abridge the text into one or more new texts shorter than the text. The abridging system 110 may preprocess the text using the text preprocessing module 120. The letter matching group module 114 may identify letter matching groups from the text. The correlation module 116 may use alphabetical matching rules stored in the alphabetical matching rules database 112 to compare letters in the letter matching groups to each other or predetermined letter groups.

The abridging system 110 may add sentences from the text that satisfy letter matching rules with both adjacent sentences based on the letter matching groups to a first new text stored in the text database 118. The abridging system 110 may add sentences that fail to satisfy letter matching rules with at least one adjacent sentence based on letter matching groups to a Second new text stored in the text database 118. The sensorial stimuli module 122 may add sensorial stimuli to the first new text, the second new text, or both.

The abridging system 110 may morphologically analyze the letters and/or letter strings of the text and/or of one or more new texts shorter than the text using the text morphologic analysis quantitative module 124.

The abridging system 110 may provide the first new text, the second new text, or both to the user device 130.

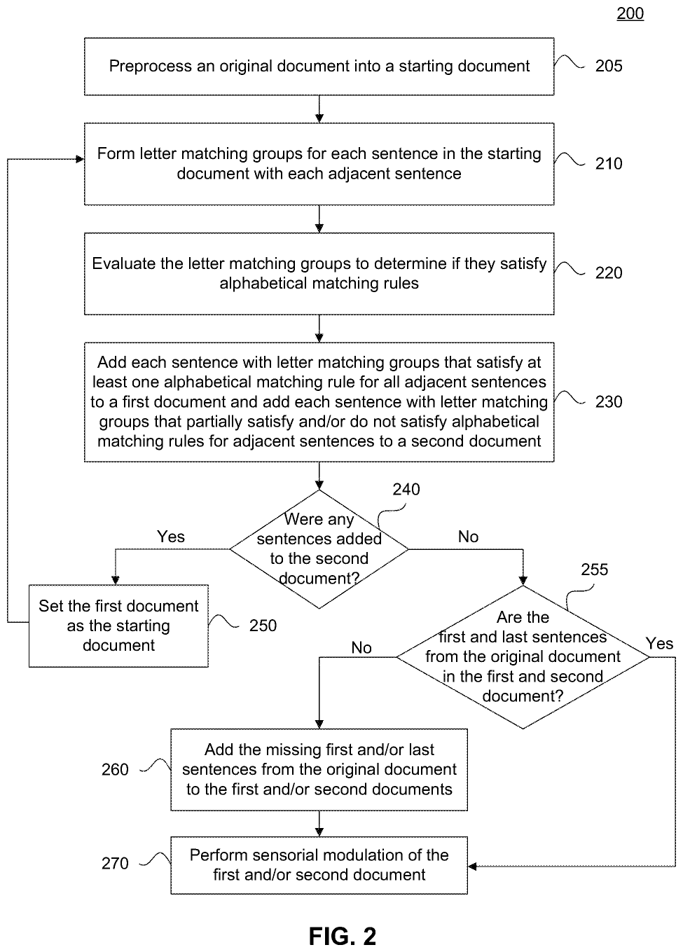

FIG. 2 depicts a method 200 for abridging texts. In 205, method 200 may preprocess an original document into a starting document. In 210, method 200 forms letter matching groups for each sentence in the starting document with each adjacent sentence. In 220, method 200 evaluates the letter matching groups to determine if they satisfy alphabetical matching rules. In 230, method 200 adds each sentence with letter matching groups that satisfy at least one alphabetical matching rule for each adjacent sentence to a first document and adds each sentence with letter matching groups that partially satisfy and/or do not satisfy alphabetical matching rules for at least one adjacent sentence to a second document. In 240, method 200 checks if there were any sentences added to the second document. If the answer is yes, method 200 branches to step 250. If the answer is no, method 200 branches to step 255. In 250, method 200 sets the first document as the starting document, then returns to step 210. In iterations performed in method 200, when method 200 returns to step 210, in repetitions of step 230, the sentences do not need to be moved to the first document because they are already in the first document. In 255, method 200 determines whether the first sentence from the original document, the last sentence from the original document, or both exist in the first and second documents. If the answer is no, at 260, method 200 adds the missing first and/or last sentences from the original document to the first and/or second documents. If the answer is yes, or after completing step 260, method 200 proceeds to 270, where method 200 performs sensorial modulation of the first and/or second document.

Further description of how the individual steps of the method 200, as performed by the abridging system 110 or other embodiments, are contained in the additional detailed description below.

One objective of this disclosure is to prompt comprehension and facilitate learning and memorization to a reader/listener, of information entailed in a first string of symbols, by a method, computer program and device, that discriminates or identifies and separates from the first string of symbols a number of contiguous arrays of symbols, and correlates these contiguous arrays of symbols according to predefined rules, to at least obtain a final separate shortest second string of symbols and a final separate shorter third string of symbols, while these shortest and shorter separate strings of symbols keeping their default relative serial order of symbols within and between their respective arrays, and inducing sensorial modulated stimuli to a layout of selected symbols of these arrays of symbols, as a stimuli to the reader/listener of the final shortest and final shorter separate strings of symbols.

A software program will discriminate or identify in a first digital Text O sentences, arrays of words and letters, and assign to each discriminated sentence an ordinal position from one to N in the first Text.

There are first and second modes for implementing the herein method.

In a First Implementation procedure of the herein method, the program will implement predefined rules by which discriminating selective symbols at selective serial ordinal positions in the string of symbols in symbol arrays, by which, parsing sentences in a first Text O. The program may discriminate in the first Text O the first and last two words of each previously parsed sentence, in order to obtain four consecutive words (hereinafter “coupling words”) from each two paired contiguous sentences.

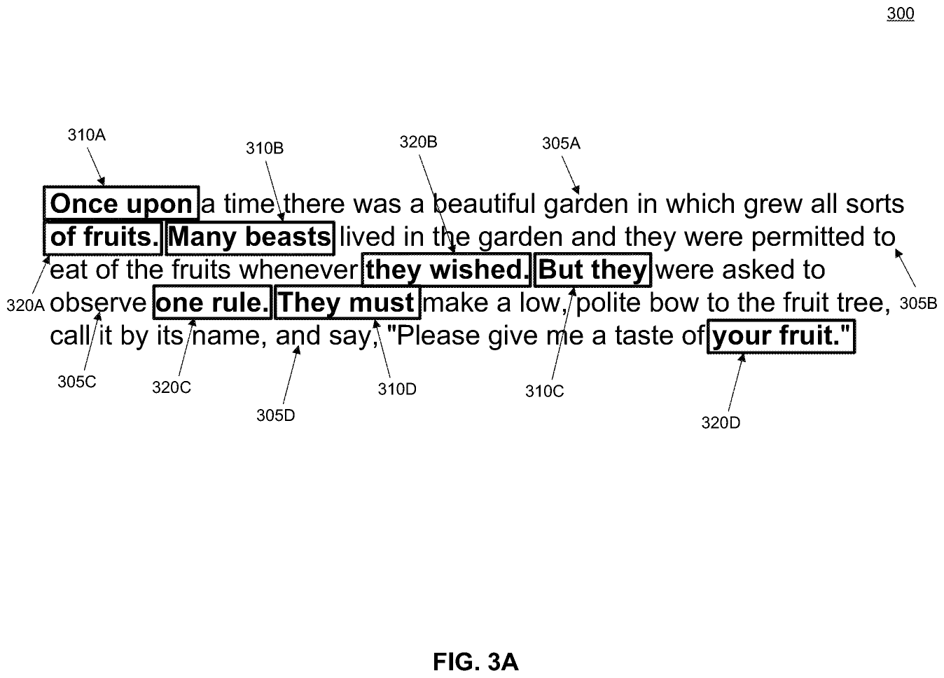

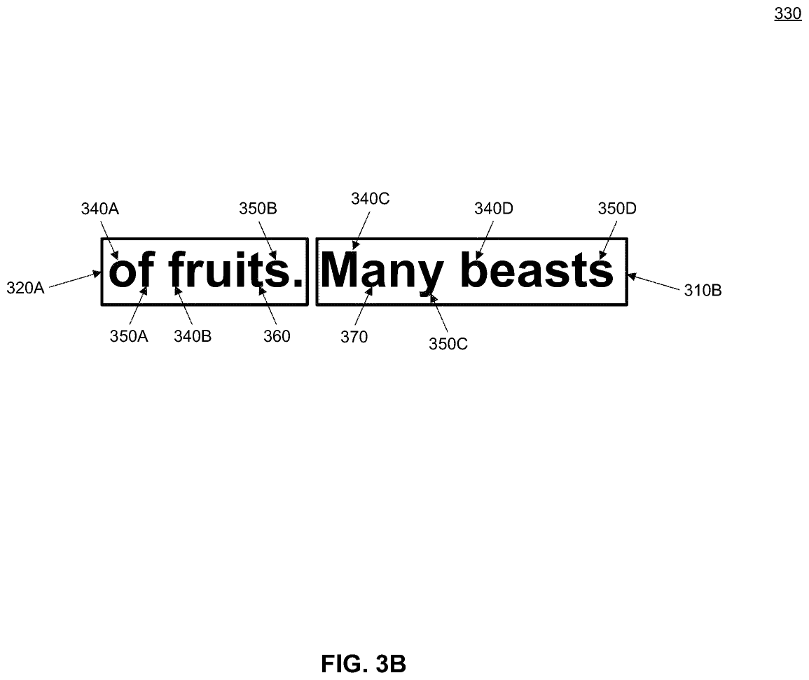

FIG. 3A illustrates an example of part of a text 300 that can be abridged. The part of the text 300 has sentences 305A, 305B, 305C, and 305D that are representative of sentences 305 that may be in a text that can be abridged. Each sentence 305 has two beginning words 310 and two ending words 320. For example, sentence 305A has two beginning words 310A, which are “Once upon,” and two ending words 320A, which are “of fruits,” both enclosed in a box and bolded. Sentence 305B has two beginning words 310B and two ending words 320B. Sentence 305C has two beginning words 310C and two ending words 320C. Sentence 305D has two beginning words 310D and two ending words 320D.

The part of a text 300 that can be abridged may take adjacent sentences and use the two ending words 320 from the initial or beginning sentence 305 in the adjacent sentences and two beginning words 310 from the subsequent or ending sentence 305 in the adjacent sentences to form a horizontal word group.

The program may algorithmically search if these paired parsed sentences are either correlated, partially correlated, or not correlated, based in matching rules among predefined letters of the said four coupling words. A sentence 305 is totally correlated if it is correlated with each adjacent sentence. A sentence 305 is partially correlated if it is only correlated with a single adjacent sentence. A sentence 305 is uncorrelated if it is not correlated with/to any adjacent sentences.

Selected letters of the four coupling words will form specific Letter Matching Groups (LMG) that are parsed based on predefined Matching Rules (MR) and set apart according to their matching categorization as correlated, non-correlated or partially correlated sentences. A separate shorter second text forms by re-grouping each of the correlated sentences and a separate shorter third text forms by re-grouping each of the remaining partially and non-correlated sentences. Repeating this separation of parsed sentences process by starting from the separate second shorter text. The first Implementation Method transforms and shortens a first Text O, providing improved comprehension and facilitation of learning and memorization of information in a reader or listener.

FIG. 3B illustrates an example horizontal word group 330 formed from the two ending words 320A from sentence 305A (shown in FIG. 3A) and the two beginning words 310B from sentence 305B (shown in FIG. 3A). The four words in the horizontal word group 330 are made up of different letters.

In this example, the first word “of” has a beginning letter 340A, which is “o,” and an ending letter 350A, which is “f.” The second word “fruits” has a beginning letter 340B, which is “f,” an ending letter 350B, which is “s,” and a second to last letter 360, which is “t.” The third word “Many” has a beginning letter 340C, which is “M,” an ending letter 350C, which is “y,” and a second from beginning letter 370, which is “a.” The last word “beasts” has a beginning letter 340D, which is “b,” and an ending letter 350D, which is “s.”

In some embodiments, alphabetical matching rules may be applied to letter matching groups formed from the horizontal word group 330. If a letter matching group satisfies at least one of the alphabetical matching rules, the two consecutive sentences from which the letter matching group is formed are said to be correlated. Sentences 305 may be in a single horizontal word group 330, such as a first sentence 305A in a text, as shown in FIG. 3A. A last sentence 305 may be in a single horizontal word group 330. However, other sentences 305 on the interior of a text, such as sentences 305B or 305C (see FIG. 3A), for example, will form horizontal word groups 330 with consecutive sentences before and after them. For example, sentence 305A will form horizontal word groups 330 with sentence 305A and sentence 305B.

In a second aspect, a layout for visual sensorial stimulation may be applied to letters of one of two predefined set of letters, where these letters are positioned at predefined positions in words and in the parsed sentences of the separate shorter texts discriminated by this method. Sensorial visual stimulation changes the font shape and RGB color of the said one set of letters in the separate shorter text, in order to induce a novel perceptual experience to the reader. The implemented set of letters is predefined. Sensorial stimulation may differ according to predefined times of the day cycle, such as regional times.

In a Second Implementation form of the method, in a first step, the program may discriminate four coupling words from four consecutive parsed sentences, wherein in its Vertical Sentence-Beginning Mode these four coupling words are obtained from the first words of these four consecutive parsed sentences, and for its Vertical Sentence-End Mode these four coupling words are obtained from the last four words of these same four consecutive parsed sentences. The four consecutive coupling words may be serially ordered according to their respective sequencing sentence position in the first Text O.

In a second step, a Letter Matching Group (LMG), entailing four letters is form. Specifically, a LMG is form with the first letter of the four coupling words in the Vertical Sentence-Beginning Mode, and with the last letter of the four coupling words in the Vertical Sentences-End Mode. By implementing the predefined Alphabetical Matching Rules (AMR), each of the four sentences can be correlated, or non-correlated with one of the other sentences. For the Vertical-Beginning and Vertical-End-Modes, a separate shorter second text is form comprising the correlated sentences, and a separate shorter third text is form comprising the non-correlated sentences. An algorithmic iteration procedure is implemented starting from the separate shorter second text, where a new LMG is form and a separate even shorter second text₁ is formed and a separate relatively larger third text₁ is form. This separation of sentences procedure repeating until a separate shortest second textₙ and a separate relatively larger third textₙ are finally formed.

In a third step, implementing sensorial stimulation to the reader/listener may be applied in the same manner as in the First Implementation Method. The Second Implementation Method for transforming and shortening a first Text O, for prompting comprehension and facilitation of learning and memorization of information, in a reader/listener is obtain.

The first Text O parses into consecutive sentences, by known methods in the Art, and according to specific requirements of this method, as detailed in this Parsing Section. Each sentence will be assigned with an ordinal number, from one to N in the first Text O.
Parsing of Sentences: Pattern recognition of a “full stop” character graphically located after the last letter of the last word in a sentence.
Parsed sentences in a text must be of two or more words. When a parsed sentence is of two words only, then a selected same serial order of letters in these two coupling words will complete the required four coupling words to execute this herein considered as Class I pairing methods for parsed sentences. When one or both parsed sentences are of one word, the algorithm may not implement matching rules on these sentences. One-word parsed sentences may be automatically included on the resulting shortened texts.
Recognition of the First word in a parsed sentence: When the First word starts with a Capital letter.
Recognition of the Last word in a parsed sentence: When the last word is followed by a full stop character ‘.’ or exclamation mark character ‘!’ or an interrogation sign character ‘?’
Parentheses: When the parenthesis shows in the middle of a sentence, the parentheses & text within it can be deleted, as an optional step. When the parenthesis shows at the end of a sentence, will not be deleted and the entailed text will be involved in the matching of sentences.
Text within Quotation Marks: when a text is in-between quotations marks (“ ”) will be considered as one single sentence unit. There are Dialogues that are comprised of more than one sentence. These multi-sentences dialogues may be treated herein as a single parsed sentence unit for matching purposes among parsed sentences.
Numerical Symbols: The following numerical symbols may be excluded from the alphabetical matching of sentences, meaning that they may not form a coupling words, but may nevertheless remain in the parsed sentences: numbers symbols (e.g. 1, 34, 0.09, etc.), numbers symbols with alphabetical symbols indicating an ordinal position (e.g. 1st, 3rd, and 10th, etc.), and roman numbers (e.g. I, III, IV, etc.)

In some embodiments, the program may algorithmically search in a first Text O for the repetitive occurrence of two types of predefined letters correlations among contiguous parsed sentences. A first type of letters correlation occurring between selective letters involving two contiguous parsed sentences and a second type of letters correlation occurring among selective letters involving four consecutive contiguous parsed sentences. These two types of letters correlations implementing the same predefined Alphabetical Matching Rules (AMR) criteria. Two types of predefined letters correlations among contiguous parsed sentences are further described below.

The algorithmic search for these predefined letters correlations among contiguous parsed sentences in a text may be implemented herein by selecting three Letters Matching Groups: the first LMG contains the first four letters of predefined (see below) four consecutive coupled words, and the second LMG contains the last four letters of the same four coupling words. The third LMG is formed from the last two letters of the second coupled word, and from the first two letters of the third coupled word.

If predefined matching rules occur in at least one of these three “Letters Matching Groups [LMG]”, then the two contiguous paired sentences from where the four coupling words where obtained, are correlated sentences. Apart from the first and last sentences, all other sentences in the first Text O are contiguously preceded and followed by a sentence; therefore it may be the case that sentences can be correlated with only one of these two contiguous parsed sentences, in this particular case sentences are named herein as, “partially correlated”.

The letter correlation among contiguous parsed sentences is designated to as belonging to Class I, namely, when a letter correlation occurs between the preceding and/or with the following contiguous parsed sentence (for example, sentence p with sentence p−1, and sentence p with sentence p+1).

The following Alphabetical Matching Rules (AMR) determines if contiguous paired sentences (the contiguous preceding and the contiguous following sentence) are correlated, non-correlated or partially correlated sentences. The AMR for the First Implementation Method are:

Matching of paired contiguous parsed sentences takes place when any two letters from the four letters in any of the 3 LMGs (obtained from the four coupling words), fulfills any of the following conditions:
a) When any two letters of the four letters of the 3 LMGs are matching letters,
b) When in the 1^{st} or 2^{nd} LMGs: the pair of letters formed by the first or the last letter of the 1^{st} & 3^{rd} coupling words and/or the pair of letters formed by the first or last letter of the 2^{nd} & 4^{th} coupling words, form a bigram of Table I; and/or in the 3^{rd} LMG: when the pair of letters formed by the last letter of the 2^{nd} coupling word, and the first letter of the 3^{rd} coupling word, form a bigram of Table I.
c) The pair of letters formed by the 1^{st} and 4^{th} letter of any LMG, are not eligible herein for matching any paired contiguous sentences.

According to the embodiments of FIG. 3, a consecutive LMG may be formed from the second to last letter 360, ending letter 350B, beginning letter 340C, and second from beginning letter 370. For the consecutive LMG, the alphabetical matching rules may include that two consecutive letters, a first and third letter, or a second and fourth letter are the same letter. The alphabetical matching rule may include that the second and third letters in the consecutive letter LMG match a letter pair for the particular language, such as those found in Table 1 for the English language below.

In some embodiments of FIG. 3, a beginning letter of the LMG is formed from the beginning letters 340A, 340B, 340C, and 340D. An alphabetical matching rule may include that two consecutive beginning letters 340, a first beginning letter 340A and a third beginning letter 340C or a second beginning letter 340B and fourth beginning letter 340D in the beginning letter of the LMG are the same letter. The alphabetical matching rule may include that the first beginning letter 340A and third beginning letter 340C or the second beginning letter 340B and fourth beginning letter 340D match a letter pair for the particular language, such as those found in Table 1 for the English language below.

In some embodiments of FIG. 3, an ending letter of the LMG is formed from the ending letters 350A, 350B, 350C, and 350D. An alphabetical matching rule may include that two consecutive letters, a first ending letter 350A and a third ending letter 350C, or a second ending letter 350B and a fourth ending letter 350D in the ending letter of the LMG are the same letter. The alphabetical matching rule may include that the first ending letter 350A and third ending letter 350C or the second ending letter 350B and fourth ending letter 350D match a letter pair for the particular language, such as those found in Table 1 for the English language below.

A sentence is considered herein to be (a) correlated, if the said correlation takes place with each adjacent contiguous sentence. For example, if a sentence has two adjacent sentences, the sentence is correlated if it is correlated with both the preceding and the following contiguous sentences. A sentence is considered herein to be (b) partially correlated, if the said partial correlation takes place with at least one, but not all adjacent contiguous sentences. For example, if a sentence has two adjacent sentences, the sentence is partially correlated if it is correlated either only with the preceding sentence or with the following contiguous sentence. A sentence is considered herein to be (c) non-correlated, if the sentence is not correlated with the adjacent sentences.

Each of the correlated contiguous parsed sentences is group into a separate second shorter “Text X”, whereas the rest of contiguous partially and/or non-correlated parsed sentences are group into a separate shorter third “Text C”.

In some embodiments, the group of sentences of Text C may be selectively sensorial discriminated within the first Text O, Text C sentences will be subject to sensorial stimulation, and the now sensorial stimulated first Text O is renamed herein O_{C}, and when the group of sentences of Text X are selectively sensorial discriminated within the first Text O, Text X sentences will be subject to sensorial stimulation, and the now sensorial stimulated first Text O is renamed herein Ox.

In some embodiments, the method of separating sentences in Text C is repeated starting from the separate shorter second Text X. The method is repeated to keep adding to Text C new sentences, which were partially correlated and/or non-correlated within the shorter second Text X, in order to obtain a new separate relatively larger third text C₁, and then to form a new separate even shorter second text X₁ derived from the remaining separate shorter Text X, and so on to obtain the separate relatively larger third Text C₂ and separate even shorter second Text X₂, until separate relatively largest third Text Cₙ and separate shortest second Text Xₙ are finally obtain. The number n depicts the iteration number at which the numerical relationship between the number of sentences in relatively largest third Text Cₙ and the number of sentences in separate shortest second Text Xₙ(Text Xₙ/Text Cₙ) represents the lowest numerical ratio. If N stands for the total number of sentences of the first Text O, then Text Xₙ+Text Cₙ=Text O_{N}. When the separate relatively largest third Text Cₙ and the separate shortest second Text Xₙ are finally obtain, the program may add the first and last sentences from the first Text O to the Text Xₙ or Text Cₙ if any of these sentences are missing.

Sentences in Text Xₙ and Text Cₙ may be sensorial modulated: Text Cₙ may be sensorial modulated by a predefined type A set of letters, and Text Xₙ, may be sensorial modulated by a predefined type B set of letters. Sensorial modulation of predefined sets A and B of letters is further described below.

Optionally, in some embodiments, the visual layout of digital texts may be subject to attention enhancement by novel sensorial visual stimulation of selective symbols in the text via the following method: selective letters strings consisting in bigrams and trigrams at predefined ordinal positions within selected words of the sentences in the transformed Texts: O_{C}, O_{X}, Cₙ and Xₙ, (see the previous section) will be subject to specific layout stimulation consisting in sensorial modulations, at predefined times of the day cycle, according to a local time of the reader or a regional time of a location where the transformed texts are being read.

A second facilitation step using five conditions may prompt comprehension and facilitate learning and memorization of information in a text, by means of applying a novel visual layout sensorial modulation to selected letters of the transformed Texts, where these sensorial modulations are implemented upon selected letters sets, herein named predefined Sets types A or B.
i) For example, if the alphabetic language of the first Text O is the English language then the selected letters of the Set type A are pairs of letters from a bigram Table I. Trigrams are also selected if they entail at least two letters of a selected bigram from Table I, as shown in Table II. For example, if the alphabetic language of the first Text O is the English language then selected letters of the Set type B are pairs of letters from a bigram Table III and trigrams from trigrams letters from Table IV. Bigrams and trigrams letters from other first Text O alphabetical languages can also be selected.
ii) When the ordinal positions of the two letters forming a bigram are: the first letter in the first word and the last letter of the last word in a sentence, or the first letter of a word and the last letter of the preceding word in a sentence, or two contiguous letters inside a word in a sentence, or the last letter of a word and the first letter of the following word in a sentence, and when the first two letters of a trigram are the first two letters in a sentence and the last trigram letter is the last letter in the last word of the same sentence; or when the first letter of a trigram is the first letter in a sentence and its two other letters are the last two letters of the same sentence, or when a trigram three letters are the contiguous letters of a last-first words located at the end and/or beginning of two contiguous sentences, or when a trigram letters are at the beginning-end of two contiguous words, or when a trigram letters are three contiguous letters inside a word, given that the said word entails at least 4 letters.
iii) Conditions i) and ii) apply to each of the words in a sentence of the respective text, with the exception of Nouns and Names words.
iv) Visual Layout Stimulations (VLS) is implemented herein by two types of sensorial modulations upon the font shape of the selected letters of i) and ii), and by two modes of flickering sensorial modulation of these selected letters. There is a Type I of VLS were the selective letters of i) and ii) will change to the Italics tilt font type shape and predefined flickering will be of a predefined RGB color, flashing during a predefined first short pre-attentive time intervals. There is a Type II of VLS were the selected letters of i) and ii) will change to a “slant backwards” font type shape, and predefined flickering will take place with a different predefined RGB color and flashing during a predefined second short pre-attentive time intervals.
v) VLS of Type I sensorial modulation occurs at specific hours of the local time of the reader, where VLS of Type II sensorial modulation occurs at different hours of the local time of the reader than Type I VLS sensorial modulation.

Text Cₙ may be sensorial modulated by the Set type A of letters, and Text Xₙ will be sensorial modulated by the Set type B of letters.

For color printed texts, condition iv—VLS) the application may implement the same change of font type shape, and RGB colors, for both, I and II Types of sensorial modulations.

In a subject sensorial audio stimulation will be implemented by two modes of predefined sound modulations of an audio source for the sentences of the transformed Texts: O_{C}, O_{X}, and transformed shortened Texts: Cₙ and Xₙ. Sound sensorial modulation involves predefined changes of Pitch and/or Amplitude and/or of Frequency. Audio modulation modes type I and II will take place at predefined different hours of the local time of the listener.

In a Second Implementation Method, the four coupling words may be obtained from four consecutive parsed sentences showing in sequential order in a first Text O, wherein in the herein contiguous Vertical Sentences-Beginning Mode, these four coupling words are selected from the first words of these four consecutive parsed sentences, and in the herein contiguous Vertical Sentences-End Mode, these four coupling words are selected from the four last words of these same four consecutive parsed sentences.

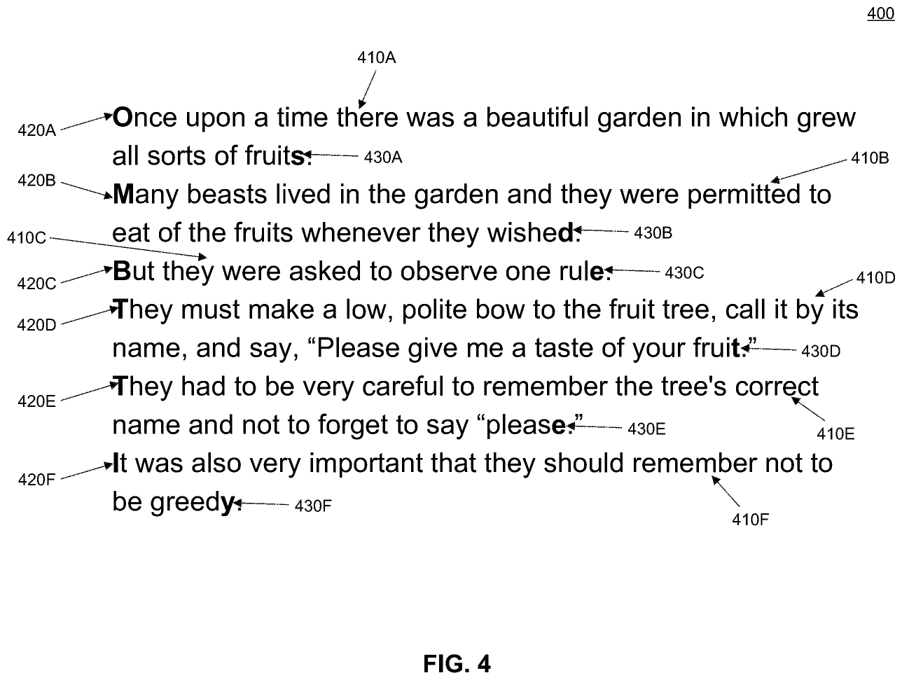

FIG. 4 illustrates an example of part of a text 400 that can be abridged. The part of the text 400 has sentences 410 such as sentences 410A, 410B, 410C, 410D, 410E and 410F. Each sentence 410 has a beginning letter 420, such as beginning letters 420A, 420B, 420C, 420D, 420E, and 420F, and an ending letter 430, such as ending letters 430A, 430B, 430C, 430D, 420E, and 430F.

The contiguous Vertical Sentences-Beginning mode of this Second Implementation Method is first discussed. The first letter of the first word of the 1^{st}, 2^{nd}, 3^{rd} and 4^{th} contiguous parsed sentences, (herein called: “4FL₁₋₄”), are the four letters herein named F₁, F₂, F₃ and F₄, forming a Letter Matching Group which is equivalent to the First Letter Matching Group of the First Implementation Method.

In some embodiments, a vertical beginning LMG may be formed from four beginning letters 420 at the beginning of four consecutive sentences 410. For example, beginning letters 420A, 420B, 420C, and 420D form a vertical beginning LMG. Beginning letters 420B, 420C, 420D, and 420E also form a vertical beginning LMG, and so forth.

Letters correlation rules taking place among pairs of parsed sentences within these four contiguous parsed sentences (excluding any letters correlation rules between the 1^{st} and the 4^{th} letters), implements the same predefined letters matching rules as in the First Implementation Method, where there is only a single Letter Matching Group to be taken into consideration. Letters correlation in the Vertical Sentences-Beginning Mode takes place under the following conditions:
i) If letters F₁=F₂, sentences 1 and 2 are correlated.
ii) If letters F₁ & F₃ are the same, or form together a bigram from Table I, sentences 1 and 3 are correlated.
iii) If letters F₂=F₃, sentences 2 and 3 are correlated.
iv) If letters F₂ & F₄ are the same, or form together a bigram from Table I, sentences 2 and 4 are correlated.
v) If letters F₃=F₄, sentences 3 and 4 are correlated.

The same algorithmic search for correlated parsed sentences is implemented for the 2^{nd}, 3^{rd}4^{th} and 5^{th} contiguous parsed sentences designated herein as 4FL₂₋₅, and then with the 4FL₃₋₆, and so on, meaning that 4FLₙ₋ₙ₊₃ fulfills a running window procedure of parsed contiguous sentences until sentence N, meaning until the 4FL_{N-3-N}. Due to this running window procedure, each contiguous parsed sentence can be correlated or non-correlated with other contiguous parsed sentences one or two times. Hence, the herein Second Implementation Method may discriminate among contiguous parsed sentences correlating at least once, and between contiguous sentences that are non-correlated.

In the contiguous Vertical Sentences-End Mode, algorithmic search for correlated and non-correlated parsed sentences implements the same specifications as above, with the difference that instead of correlating the first letters of the first four words of the four contiguous parsed sentences this time the method herein correlating the last letters, L₁, L₂, L₃, and L₄ of the last four words of the same four contiguous parsed sentences. Correlation in the Vertical Sentences-End Mode is determined by a LMG equivalent to the Second Matching Group of the First Implementation Method.

In some embodiments, a vertical ending LMG may be formed from four ending letters 430 at the end of four consecutive sentences 410. For example, ending letters 430A, 430B, 430C, and 430D form a vertical ending LMG. Ending letters 430B, 430C, 430D, and 430E also form a vertical ending LMG, and so forth.

In some embodiments, the vertical beginning LMGs and the vertical ending LMGs may be checked or evaluated for correlation by application of the alphabetical matching rules described above for the Vertical Sentences-Beginning Mode and for the Vertical Sentences-End Mode, respectively.

A separate second Text Y, shorter than the first Text O, may be formed from each of the correlated parsed sentences of the Vertical Sentences-Beginning Mode, and a separate third Text G shorter than the first Text O, may be formed comprising each of the non-correlated sentences of this Vertical Sentences-Beginning Mode. In the same way, two separate shorter Texts are obtain from the algorithmic correlation in the Vertical Sentences-End Mode, named herein as separate shorter second Text Z comprising each of the correlated sentences and a separate shorter third Text H comprising each of the non-correlated sentences.

In a similar methodological fashion to the First Implementation Method, from a first Text O a separate shorter second Text Y is formed only comprising the correlated sentences from the first Text O. Accordingly, a new separate short third Text G is also formed only comprising the removed non-correlated sentences from first Text O. The separate shorter second Text Y transforms again into an even shorter separate second Text Y₁, if and when a second iteration is implemented and an additional removal of non-correlated sentences from separate second even shorter Text Y₁ comes to effect, forming this time a relatively larger separate third Text G₁ and so on until the final relative largest separate third Text Gₙ and the final separate shortest second Text Yₙ, are obtain and where the numerical relationship between the final total number of sentences in the separate shortest Text Yₙ in relation to the final total number of sentences in the separate relatively largest Text Gₙ(Yₙ/Gₙ) represents the lowest numerical ratio.

If the total number of sentences in the first Text O is N, then the number of sentences comprising separate shortest final Text Yₙ plus the number of sentences comprising separate relatively largest final Text Gₙ will be equal to N. Once the final separate Texts Yₙ and Gₙ are obtain, the program will automatically add the first and last sentences entailed in the first Text O to the separate shortest Text Yₙ or relatively largest text Gₙ in case any of these two sentences were missing.

Following the same methodology as in the Vertical Sentence-Beginning Mode from the first Text O a separate shorter second Text Z, may be obtained comprising each of the correlated sentences and a separate short third Text H comprising each of the non-correlated sentences will be obtain for the Vertical Sentence-End Mode. Continuing the same methodological fashion as in the Vertical Sentence-Beginning Mode, through additional algorithmic iterations a final shortest separate second final Text Zₙ comprising correlated sentences and a final relatively largest separate third Text Hₙ comprising non-correlated sentences are obtain.

Layout sensorial modulations may be applied to the correlated sentences of final separate shortest second Texts Yₙ and Zₙ according to predefined Set type B of letters, and to non-correlated sentences of final separate relatively largest third Texts Gₙ and Hₙ, according to predefined Set type A of letters, in agreement with the same specifications from the First Implementation Method.

Audio sensorial modulation upon predefine Sets type A and B letters may be performed in the same way as described above.

### Sensorial Modulation—Set Type ‘A’ of Letters—Table I: Bigrams & Table II: Trigrams

The following tables are examples of bigrams and trigrams for type sensorial modulation.

TABLE I
For the English Language-The 50 Letters Pairs (Bigrams)

| | | | |
|---|---|---|---|
| 1 | AZ | 1 | ZA |
| 2 | BY | 2 | YB |
| 3 | CX | 3 | XY |
| 4 | DW | 4 | WD |
| 5 | EV | 5 | VE |
| 6 | FU | 6 | UF |
| 7 | GT | 7 | TG |
| 8 | HS | 8 | SH |
| 9 | IR | 9 | RI |
| 10 | JQ | 10 | QJ |
| 11 | KP | 11 | PK |
| 12 | LO | 12 | OL |
| 13 | MN | 13 | NM |
| 1 | AN | 1 | NA |
| 2 | BO | 2 | OB |
| 3 | CP | 3 | PC |
| 4 | DQ | 4 | QD |
| 5 | ER | 5 | RE |
| 6 | FS | 6 | SF |
| 7 | HU | 7 | UH |
| 8 | IV | 8 | VI |
| 9 | JW | 9 | WJ |
| 10 | KX | 10 | XK |
| 11 | LY | 11 | YL |
| 12 | MZ | 12 | ZM |

TABLE II
For the English Language-The 150 Trigrams

| | | | | | |
|---|---|---|---|---|---|
| 1 | AAZ | 1 | AZA | 1 | ZAA |
| 2 | ZZA | 2 | ZAZ | 2 | AZZ |
| 3 | BBY | 3 | BYB | 3 | YBB |
| 4 | YYB | 4 | YBY | 4 | BYY |
| 5 | CCX | 5 | CXC | 5 | XCC |
| 6 | XXC | 6 | XCX | 6 | CXX |
| 7 | DDW | 7 | DWD | 7 | WDD |
| 8 | WWD | 8 | WDW | 8 | DWW |
| 9 | EEV | 9 | EVE | 9 | VEE |
| 10 | VVE | 10 | VEV | 10 | EVV |
| 11 | FFU | 11 | FUF | 11 | UFF |
| 12 | UUF | 12 | UFU | 12 | FUU |
| 13 | GGT | 13 | GTG | 13 | TGG |
| 14 | TTG | 14 | TGT | 14 | GTT |
| 15 | HHS | 15 | HSH | 15 | SHH |
| 16 | SSH | 16 | SHS | 16 | HSS |
| 17 | IIR | 17 | IRI | 17 | RII |
| 18 | RRI | 18 | RIR | 18 | IRR |
| 19 | JJQ | 19 | JQJ | 19 | QJJ |
| 20 | QQJ | 20 | QJQ | 20 | JQQ |
| 21 | KKP | 21 | KPK | 21 | PKK |
| 22 | PPK | 22 | PKP | 22 | KPP |
| 23 | LLO | 23 | LOL | 23 | OLL |
| 24 | OOL | 24 | OLO | 24 | LOO |
| 25 | MMN | 25 | MNM | 25 | NMM |
| 26 | NNM | 26 | NMN | 26 | MNN |
| 1 | AAN | 1 | ANA | 1 | NAA |
| 2 | NNA | 2 | NAN | 2 | ANN |
| 3 | BBO | 3 | BOB | 3 | OBB |
| 4 | OOB | 4 | OBO | 4 | BOO |
| 5 | CCP | 5 | CPC | 5 | PCC |
| 6 | PPC | 6 | PCP | 6 | CPP |
| 7 | DDQ | 7 | DQD | 7 | QDD |
| 8 | QQD | 8 | QDQ | 8 | DQQ |
| 9 | EER | 9 | ERE | 9 | REE |
| 10 | RRE | 10 | RER | 10 | ERR |
| 11 | FFS | 11 | FSF | 11 | SFF |
| 12 | SSF | 12 | SFS | 12 | FSS |
| 13 | HHU | 13 | HUH | 13 | UHH |
| 14 | UUH | 14 | UHU | 14 | HUU |
| 15 | IIV | 15 | IVI | 15 | VII |
| 16 | VVI | 16 | VIV | 16 | IVV |
| 17 | JJW | 17 | JWJ | 17 | WJJ |
| 18 | WWJ | 18 | WJW | 18 | JWW |
| 19 | KKX | 19 | KXK | 19 | XKK |
| 20 | XXK | 20 | XKX | 20 | KXX |
| 21 | LLY | 21 | LYL | 21 | YLL |
| 22 | YYL | 22 | YLY | 22 | LYY |
| 23 | MMZ | 23 | MZM | 23 | ZMM |
| 24 | ZZM | 24 | ZMZ | 24 | MZZ |

### Sensorial Modulation—Set Type ‘B’ of Letters—Table III: Bigrams & Table IV: Trigrams

The following tables are examples of bigrams and trigrams for type sensorial modulation.

TABLE III
For the English Language-The 50 Letters Pairs (Bigrams)

| | | | |
|---|---|---|---|
| 1 | AB | 1 | BA |
| 2 | BC | 2 | CB |
| 3 | CD | 3 | DC |
| 4 | DE | 4 | ED |
| 5 | EF | 5 | FE |
| 6 | FG | 6 | GF |
| 7 | GH | 7 | HG |
| 8 | HI | 8 | IH |
| 9 | IJ | 9 | JI |
| 10 | JK | 10 | KJ |
| 11 | KL | 11 | LK |
| 12 | LM | 12 | ML |
| 13 | MN | 13 | NM |
| 14 | NO | 14 | ON |
| 15 | OP | 15 | PO |
| 16 | PQ | 16 | QP |
| 17 | QR | 17 | RQ |
| 18 | RS | 18 | SR |
| 19 | ST | 19 | TS |
| 20 | TU | 20 | UT |
| 21 | UV | 21 | VU |
| 22 | VW | 22 | WV |
| 23 | WX | 23 | XW |
| 24 | XY | 24 | YX |
| 25 | YZ | 25 | ZY |

TABLE IV
For the English Language-The 150 Trigrams

| | | | | | |
|---|---|---|---|---|---|
| 1 | AAB | 1 | ABA | 1 | BAA |
| 2 | BBA | 2 | BAB | 2 | ABB |
| 3 | BBC | 3 | BCB | 3 | CBB |
| 4 | CCB | 4 | CBC | 4 | BCC |
| 5 | CCD | 5 | CDC | 5 | DCC |
| 6 | DDC | 6 | DCD | 6 | CDD |
| 7 | DDE | 7 | DED | 7 | EDD |
| 8 | EED | 8 | EDE | 8 | DEE |
| 9 | EEF | 9 | EFE | 9 | FEE |
| 10 | FFE | 10 | FEF | 10 | EEF |
| 11 | FFG | 11 | FGF | 11 | GFF |
| 12 | GGF | 12 | GFG | 12 | FGG |
| 13 | GGH | 13 | GHG | 13 | HGG |
| 14 | HHG | 14 | HGH | 14 | GHH |
| 15 | HHI | 15 | HIH | 15 | IHH |
| 16 | IIH | 16 | IHI | 16 | HII |
| 17 | IIJ | 17 | IJI | 17 | JII |
| 18 | JII | 18 | JIJ | 18 | IJJ |
| 19 | JJK | 19 | JKJ | 19 | KJJ |
| 20 | KKJ | 20 | KJK | 20 | JKK |
| 21 | LLK | 21 | LKL | 21 | KLL |
| 22 | KKL | 22 | KLK | 22 | LKK |
| 23 | MML | 23 | MLM | 23 | LMM |
| 24 | LLM | 24 | LML | 24 | MILL |
| 25 | NNM | 25 | NMN | 25 | MNN |
| 26 | MMN | 26 | MNM | 26 | NMM |
| 27 | OON | 27 | ONO | 27 | NOO |
| 28 | NNO | 28 | NON | 28 | ONN |
| 29 | PPO | 29 | POP | 29 | OPP |
| 30 | OOP | 30 | OPO | 30 | POO |
| 31 | PPQ | 31 | PQP | 31 | QPP |
| 32 | QQP | 32 | QPQ | 32 | PQQ |
| 33 | RRQ | 33 | RQR | 33 | QRR |
| 34 | QQR | 34 | QRQ | 34 | RQQ |
| 35 | SSR | 35 | SRS | 35 | RSS |
| 36 | RRS | 36 | RSR | 36 | SRR |
| 37 | TTS | 37 | TST | 37 | STT |
| 38 | SST | 38 | STS | 38 | TSS |
| 39 | UUT | 39 | UTU | 39 | TUU |
| 40 | TTU | 40 | TUT | 40 | UTT |
| 41 | VVU | 41 | VUV | 41 | UVV |
| 42 | UUV | 42 | UVU | 42 | VUU |
| 43 | WWV | 43 | WVW | 43 | VWW |
| 44 | VVW | 44 | VWV | 44 | WVV |
| 45 | XXW | 45 | XWX | 45 | WXX |
| 46 | WWX | 46 | WXW | 46 | XWW |
| 47 | YYX | 47 | YXY | 47 | XYY |
| 48 | XXY | 48 | XYX | 48 | YXX |
| 49 | ZZY | 49 | ZYZ | 49 | YZZ |
| 50 | YYZ | 50 | YZY | 50 | ZYY |

### Reading Complexity

In some embodiments, the methods and systems described herein may improve the readability of a text through abridgement. Through abridgement, replacement of words, or both, the original text may be transformed so that its information content resulting more fluent, comprehensible and easy to learn-memorize. The improvement may be measured by a Readability Score (RS). The RS provides a statistical numeric gauge of the comprehension and learning retention difficulty that readers come upon when reading a text.

In some embodiments, the methods and systems described herein may include an algorithm that computes the RS of the first Text O. This algorithm may use the Dale-Chall formula for establishing a base line about reading flow, ease of content memorization and comprehension difficulty of the text. The algorithm may determine the RS for every new generated abridged text. This may allow the methods and systems described herein to simplify algorithmically the information content of any given first Text O by transforming and then generating one or more abridged texts.

The Dale-Chall readability formula is a readability or reading comprehension test that provides a numeric statistical gauge of the comprehension difficulty that readers come upon when reading a text. It uses a list of 3000 familiar words that fourth-grade American students could reliably understand, and considers any word not on that list to be difficult or unfamiliar. The more unfamiliar words used in a document, the higher the reading level of the document. The Dale-Chall readability formula gives a significant correlation with reading difficulty, including correlating with reading tests. The Dale-Chall formula is used in a variety of scientific research.

The Dale-Chall formula selects 100-word samples throughout the text, computes the average sentence length in words, computes a percentage of words not on the Dale Chall list, and then calculates a formula. The formula is:

Raw score=64−0.95*(PDW)−0.69*(ASL),

where Raw Score is the reading grade of a reader who can comprehend the text at 4rd grade or below (uncorrected reading grade of a student who can answer one-half of the test questions on a passage), PDW is the percentage of difficult words not on the Dale-Chall word list, and ASL is the average sentence length in words.

The Raw Score may be adjusted to determine the reading grade of a reader at other grade levels. For example, if PDW is greater than 5%, then, the score may be adjusted according to the following:

Adjusted Score=Raw Score+3.6365

Otherwise, the Raw Score is not adjusted. This adjusted score can be used to determine the reading grade of a reader who can comprehend your text at 4th grade or above.

The final score, which is the Raw Score or the Adjusted Score, as appropriate, can be evaluated according to the table below to determine the reading grade for the text.

| Raw Score | Final Score |
|---|---|
| 4.9 and below | Grade 4 and below |
| 5.0-5.9 | Grades 5-6 |
| 6.0-6.9 | Grades 7-8 |
| 7.0-7.9 | Grades 9-10 |
| 8.0-8.9 | Grades 11-12 |
| 9.0-9.9 | Grades 13-15 (College) |
| 10 and above | Grades 16 and above |
| | (College Graduate) |

Referring now back to the methods, in some texts, the number of words not included in the Dale-Chall list may be reduced by abridgement. The abridgement may reduce the number of words not in the Dale-Chall list and decrease the length of the remaining sentences. This may lower the Raw Score of the abridged text, which means that the information content in the abridged texts is simpler, more comprehensible, and easier to learn and memorize.

In some embodiments, the abridging methods may be supplemented by replacing words in the text or abridged text. For example, words in the text or abridged text that are not included in the Dale-Chall list may be replaced with words in the Dale-Chall list that have similar meanings. This replacement of words in the text will lower the Raw Score of the abridged text making the text easier to read and more comprehensible.

### Applications

In some embodiments, method 200 is implemented as part of an application on a website or computer software to abridge a selection of texts from the website or the computer software. The application may then provide the abridged selection to another device via a transmission, email, or other communication method.

Such an approach may be useful when trying to read articles in a news feed or social media feed. For example, due to the length and quantity of articles in the feed. And due to the quantity of articles in such feeds, a user may miss articles entirely.

The application described may allow a user to select documents, such as news articles, in a feed, such as by tapping on the document or a separate interface element. The application will abridge the documents and provide them to the user, such as through a link to another program, an email, or other communication. The user may then access the abridged documents at a convenient time.

The abridged documents may be provided as text, audio, or video files. The abridged documents may be subjected to text to speech conversion to generate an audio file. An audio file may be combined with a computerized avatar to create a video file. The user may then read, listen to, or watch the documents at a convenient time. In some embodiments, the audio or video files may use the user's voice or an avatar of the user.

For example, a social media user may see a long-form news article linked on their feed that they wish to read. The social media feed may present an option to send the document, in abridged form, to a destination, such as an email address or a specific device. This allows the user for example, to access an abridged version of the long-form article from a connected e-reader or other mobile device when convenient, or to listen to a text-to-speech translated copy of the abridged article from their phone during their commute.

In some embodiments, the method 200 may be used as part of an application that enhances searching. For example, the application may abridge text to be searched, reducing the text to a clear, optimized, and simplified text. This may enhance searching results because there is less text to search, and the text is limited to the most relevant portions. As a result, the search result will direct to those most relevant portions of the text even if the search string itself occurs frequently in the unabridged text. The application may improve searching by providing results without extraneous information, such as advertisements, highlights, images, photos, videos, pop-ups, and other portions of search results that are not part of the searched-for text.

The algorithm may identify which portions of a search result are most relevant to the text. This may include identifying photos, videos, pop-ups, advertisements, and other extraneous information. The algorithm may include features to indicate what type of content to strip from the search results to aid in abridging.

The search results may provide a user with a link to the original website based on the search of the abridged results, a link to the original text stripped of the extraneous information, or a link to the abridged text. The application may provide an interface element, such as a link or button, which allows the user to switch between the different links.

In some embodiments, method 200 may be used as part of an aid for students. The length of study materials, textbooks, or other reading assignments can be difficult for students to digest. The abridged text may reduce the length of time that students need to read. The abridged text may increase reading comprehension, and improve the learning process.

For example, a website or application may provide a pre-selected set of abridged materials based on common documents used in coursework or a specified list provided by an instructor. The website or application may allow a user to submit a list of documents to abridge. The user may provide the documents in the list or the website or application may search a database or the internet for the documents in the list.

In a similar way, the application may be applied to research, such as market research. The application may simplify complex deep due diligence and market research work involving extensive data and help researchers to better cope with huge amount of text, and to faster review digital documents & more rapidly detect selective data. Digital document management may be optimized. The abridged texts from different sources may be used to generate research findings and a simplified final report.

For example, a set of documents to be researched may be provided to be abridged. The resulting abridged set of documents is shorter and still provides the necessary information to understand the documents. The amount of time to review may be reduced and researchers may identify documents that require more investigation, if necessary.

In some embodiments, method 200 may be applied as part of editing software that can help the drafter of a text to edit the text's drafts and convert them into abridged, optimized and significant articles. Editors may use the abridged texts to rank the digital manuscript drafts they receive from writers from a pure alphabetical morphological standpoint, rapidly evaluating the flow and consistency of the text's narrative.

For example, editors or authors may abridge documents to create shorter documents for publication. Or the editors or authors may abridge documents for review to help better understand the content of the document prior to editing the unabridged version.

In some embodiments, method 200 may be used as part of an application to transcribe audio or video content. This may allow for automated transcription and summarization of an audio or video file.

In some embodiments, method 200 may be used to optimize large text datasets. This may improve clarity and make the dataset more comprehensible. For example, abridgement may aid in simplifying call transcription and provide a clearer and comprehensible abridged format for the transcriptions.

For example, a call center may use the abridgement methods to abridge call records. This may allow for easier review of the call records. The abridged call records may reduce storage requirements.

In some embodiments, method 200 may be used to improve readability of a text to a targeted level. A user may select a desired reading level and the text is abridged. If the resulting abridged text does yet, not meet the desired reading level, the original text or the abridged text may be modified by replacing words that are not in the Dale-Chall list with words that are in the Dale-Chall list. The number and specific morphological type of words chosen may be selected to provide a Raw Score that matches the desired reading level. In this way, the text may be abridged and simplified for a user according to the desired level of complexity.

In some embodiments, method 200 may be used to improve reading intelligibility. When considering the amount of reading taking place on electronic devices, the application of special text layout methodologies may lead to a noticeable improvement of reading intelligibility. Indeed, when the abridged text is of a novel structure layout, such as provided in accordance with methods described herein, and in particular when the abridged text entirely fits in a single page/screen, it may dramatically improve and facilitate reading comprehension.

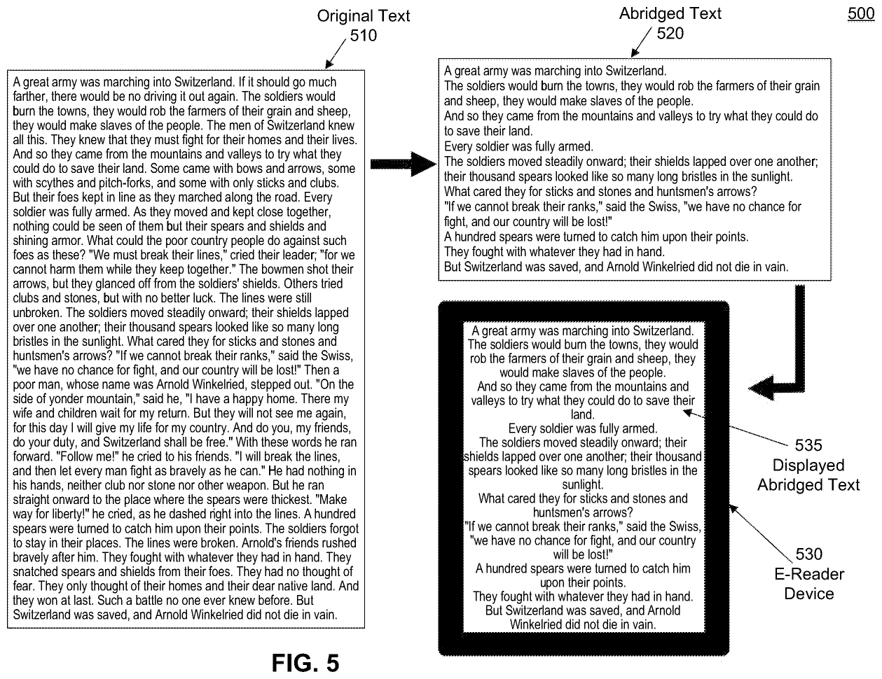

FIG. 5 illustrates an example of a text abridgement 500, which shows an original text 510, an abridged text 520, an e-reader device 530, and a displayed abridged text 535. This example of a text abridgement 500 is representative of a variety of abridgement scenarios for various devices similar to the e-reader 530, such as computers, mobile devices, cell phones, or tablets.

The original text 510 may not fit on the display of the e-reader device 530. By abridging the text using methods and systems as described herein, abridged text 520 is generated. This abridged text 520 is of a novel visual layout structure, therefore prompting and enhancing reading comprehension of the text and may be displayed on a single screen on the e-reader device 530 as displayed abridged text 535. It is to be understood that not all abridged text 520 may be displayed on a single screen on the e-reader device 530, but that abridged text 520 will take up less space and fewer screens than the original text 510.

In some embodiments, method 200 may stop abridging once the abridged text reaches a certain size. The abridged text size may be a page size or number of pages at a specified text font size on a mobile device, such as the e-reader device 530. A preferable abridged text size may be specified by a user or may be algorithmically based on a specified device according to selective novel typographical visual crowding principles on which the abridged text is to be displayed. The device may be automatically detected as part of the application or as a device performing the abridgement.

### Example Text Abridgement

As an example of a text abridgement, the following text entitled “Arnold Winkelried” by James Baldwin, containing 468 words, was analyzed:
A great army was marching into Switzerland. If it should go much farther, there would be no driving it out again. The soldiers would burn the towns, they would rob the farmers of their grain and sheep, they would make slaves of the people. The men of Switzerland knew all this. They knew that they must fight for their homes and their lives. And so they came from the mountains and valleys to try what they could do to save their land. Some came with bows and arrows, some with scythes and pitch-forks, and some with only sticks and clubs. But their foes kept in line as they marched along the road. Every soldier was fully armed. As they moved and kept close together, nothing could be seen of them but their spears and shields and shining armor. What could the poor country people do against such foes as these? “We must break their lines,” cried their leader; “for we cannot harm them while they keep together.” The bowmen shot their arrows, but they glanced off from the soldiers' shields. Others tried clubs and stones, but with no better luck. The lines were still unbroken. The soldiers moved steadily onward; their shields lapped over one another; their thousand spears looked like so many long bristles in the sunlight. What cared they for sticks and stones and huntsmen's arrows? “If we cannot break their ranks,” said the Swiss, “we have no chance for fight, and our country will be lost!” Then a poor man, whose name was Arnold Winkelried, stepped out. “On the side of yonder mountain,” said he, “I have a happy home. There my wife and children wait for my return. But they will not see me again, for this day I will give my life for my country. And do you, my friends, do your duty, and Switzerland shall be free.” With these words he ran forward. “Follow me!” he cried to his friends. “I will break the lines, and then let every man fight as bravely as he can.” He had nothing in his hands, neither club nor stone nor other weapon. But he ran straight onward to the place where the spears were thickest. “Make way for liberty!” he cried, as he dashed right into the lines. A hundred spears were turned to catch him upon their points. The soldiers forgot to stay in their places. The lines were broken. Arnold's friends rushed bravely after him. They fought with whatever they had in hand. They snatched spears and shields from their foes. They had no thought of fear. They only thought of their homes and their dear native land. And they won at last. Such a battle no one ever knew before. But Switzerland was saved, and Arnold Winkelried did not die in vain.

Using methods disclosed herein, the text was separated into a second shorter text X with 379 words:
A great army was marching into Switzerland. If it should go much farther, there would be no driving it out again. The men of Switzerland knew all this. They knew that they must fight for their homes and their lives. Some came with bows and arrows, some with scythes and pitch-forks, and some with only sticks and clubs. But their foes kept in line as they marched along the road. As they moved and kept close together, nothing could be seen of them but their spears and shields and shining armor. What could the poor country people do against such foes as these? “We must break their lines,” cried their leader; “for we cannot harm them while they keep together.” The bowmen shot their arrows, but they glanced off from the soldiers' shields. Others tried clubs and stones, but with no better luck. The lines were still unbroken. What cared they for sticks and stones and huntsmen's arrows? “If we cannot break their ranks,” said the Swiss, “we have no chance for fight, and our country will be lost!” Then a poor man, whose name was Arnold Winkelried, stepped out. “On the side of yonder mountain,” said he, “I have a happy home. There my wife and children wait for my return. But they will not see me again, for this day I will give my life for my country. And do you, my friends, do your duty, and Switzerland shall be free.” With these words he ran forward. “Follow me!” he cried to his friends. “I will break the lines, and then let every man fight as bravely as he can.” He had nothing in his hands, neither club nor stone nor other weapon. But he ran straight onward to the place where the spears were thickest. “Make way for liberty!” he cried, as he dashed right into the lines. The soldiers forgot to stay in their places. The lines were broken. Arnold's friends rushed bravely after him. They snatched spears and shields from their foes. They had no thought of fear. They only thought of their homes and their dear native land. And they won at last. Such a battle no one ever knew before. But Switzerland was saved, and Arnold Winkelried did not die in vain.

The original text was also divided into a third shorter text C consisting of 108 words:
A great army was marching into Switzerland.
The soldiers would burn the towns, they would rob the farmers of their grain and sheep, they would make slaves of the people.
And so they came from the mountains and valleys to try what they could do to save their land.
Every soldier was fully armed.
The soldiers moved steadily onward; their shields lapped over one another; their thousand spears looked like so many long bristles in the sunlight.
A hundred spears were turned to catch him upon their points.
They fought with whatever they had in hand.
But Switzerland was saved, and Arnold Winkelried did not die in vain.

As discussed, these texts X and C are shorter than the original text. The abridgement continues further, as described above.

This results in second shorter text X₁ with 369 words:
A great army was marching into Switzerland. If it should go much farther, there would be no driving it out again. The men of Switzerland knew all this. They knew that they must fight for their homes and their lives. Some came with bows and arrows, some with scythes and pitch-forks, and some with only sticks and clubs. But their foes kept in line as they marched along the road. As they moved and kept close together, nothing could be seen of them but their spears and shields and shining armor. What could the poor country people do against such foes as these? “We must break their lines,” cried their leader; “for we cannot harm them while they keep together.” The bowmen shot their arrows, but they glanced off from the soldiers' shields. Others tried clubs and stones, but with no better luck. The lines were still unbroken. “If we cannot break their ranks,” said the Swiss, “we have no chance for fight, and our country will be lost!” Then a poor man, whose name was Arnold Winkelried, stepped out. “On the side of yonder mountain,” said he, “I have a happy home. There my wife and children wait for my return. But they will not see me again, for this day I will give my life for my country. And do you, my friends, do your duty, and Switzerland shall be free.” With these words he ran forward. “Follow me!” he cried to his friends. “I will break the lines, and then let every man fight as bravely as he can.” He had nothing in his hands, neither club nor stone nor other weapon. But he ran straight onward to the place where the spears were thickest. “Make way for liberty!” he cried, as he dashed right into the lines. The soldiers forgot to stay in their places. The lines were broken. Arnold's friends rushed bravely after him. They snatched spears and shields from their foes. They had no thought of fear. They only thought of their homes and their dear native land. And they won at last. Such a battle no one ever knew before. But Switzerland was saved, and Arnold Winkelried did not die in vain.

It also results in a third shorter text C₁ with 118 words:
A great army was marching into Switzerland.
The soldiers would burn the towns, they would rob the farmers of their grain and sheep, they would make slaves of the people.
And so they came from the mountains and valleys to try what they could do to save their land.
Every soldier was fully armed.
The soldiers moved steadily onward; their shields lapped over one another; their thousand spears looked like so many long bristles in the sunlight.
What cared they for sticks and stones and huntsmen's arrows?
A hundred spears were turned to catch him upon their points.
They fought with whatever they had in hand.
But Switzerland was saved, and Arnold Winkelried did not die in vain.

At the next step, which in this example is the final step, a second shorter text Xₙ that has 348 words is obtained. This final abridgement step represents about a twenty-six percent reduction from the original text. This second shorter text Xₙ is:
A great army was marching into Switzerland. If it should go much farther, there would be no driving it out again. The men of Switzerland knew all this. They knew that they must fight for their homes and their lives. Some came with bows and arrows, some with scythes and pitch-forks, and some with only sticks and clubs. But their foes kept in line as they marched along the road. As they moved and kept close together, nothing could be seen of them but their spears and shields and shining armor. What could the poor country people do against such foes as these? “We must break their lines,” cried their leader; “for we cannot harm them while they keep together.” The bowmen shot their arrows, but they glanced off from the soldiers' shields. Others tried clubs and stones, but with no better luck. The lines were still unbroken. Then a poor man, whose name was Arnold Winkelried, stepped out. “On the side of yonder mountain,” said he, “I have a happy home. There my wife and children wait for my return. But they will not see me again, for this day I will give my life for my country. And do you, my friends, do your duty, and Switzerland shall be free.” With these words he ran forward. “Follow me!” he cried to his friends. “I will break the lines, and then let every man fight as bravely as he can.” He had nothing in his hands, neither club nor stone nor other weapon. But he ran straight onward to the place where the spears were thickest. “Make way for liberty!” he cried, as he dashed right into the lines. The soldiers forgot to stay in their places. The lines were broken. Arnold's friends rushed bravely after him. They snatched spears and shields from their foes. They had no thought of fear. They only thought of their homes and their dear native land. And they won at last. Such a battle no one ever knew before. But Switzerland was saved, and Arnold Winkelried did not die in vain.

The corresponding third shortest text Cₙ has 139 words, this final abridgment step represents a reduction of about seventy percent over the original text. This shortest text Cₙ is:
A great army was marching into Switzerland.
The soldiers would burn the towns, they would rob the farmers of their grain and sheep, they would make slaves of the people.
And so they came from the mountains and valleys to try what they could do to save their land.
Every soldier was fully armed.
The soldiers moved steadily onward; their shields lapped over one another; their thousand spears looked like so many long bristles in the sunlight.
What cared they for sticks and stones and huntsmen's arrows?
“If we cannot break their ranks,” said the Swiss, “we have no chance for fight, and our country will be lost!”
A hundred spears were turned to catch him upon their points.
They fought with whatever they had in hand.
But Switzerland was saved, and Arnold Winkelried did not die in vain.

This is exemplary of the kind of reduction that the methods and systems disclosed herein may accomplish. It will be understood that, for different texts, the amount of reduction will vary.

### Example Computer System

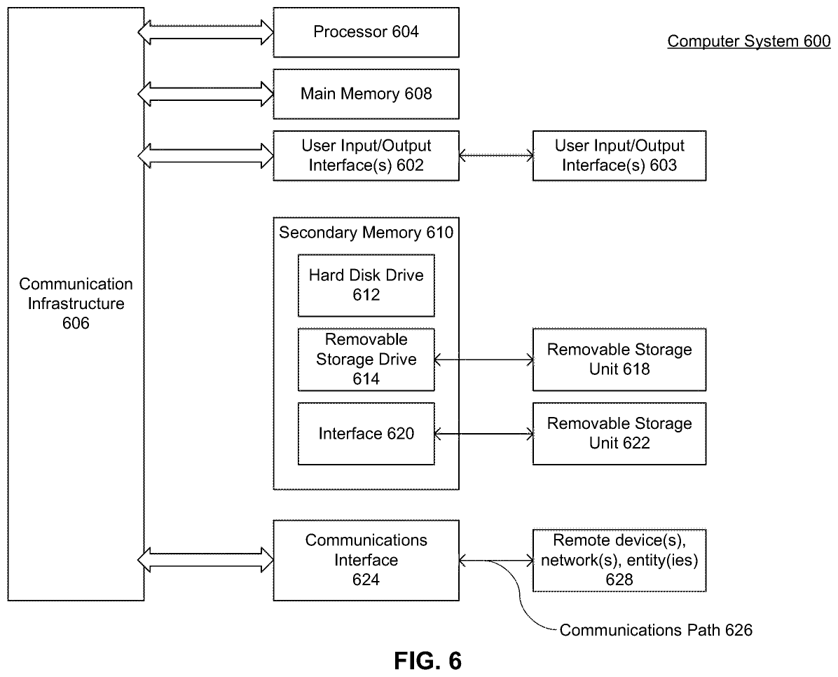

Various embodiments may be implemented, for example, using one or more computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a bus or communication infrastructure 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, vector processing, array processing, etc., as well as cryptography (including brute-force cracking), generating cryptographic hashes or hash sequences, solving partial hash-inversion problems, and/or producing results of other proof-of-work computations for some blockchain-based applications, for example. With capabilities of general-purpose computing on graphics processing units (GPGPU), the GPU may be particularly useful in at least the image recognition and machine learning aspects described herein.

Additionally, one or more of processors 604 may include a coprocessor or other implementation of logic for accelerating cryptographic calculations or other specialized mathematical functions, including hardware-accelerated cryptographic coprocessors. Such accelerated processors may further include instruction set(s) for acceleration using coprocessors and/or other logic to facilitate such acceleration.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or secondary memory 610. Secondary memory 610 may include, for example, a main storage drive 612 and/or a removable storage device or drive 614. Main storage drive 612 may be a hard disk drive or solid-state drive, for example. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communication path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet of Things (IoT), and/or embedded system, to name a few non-limiting examples, or any combination thereof.

It should be appreciated that the framework described herein may be implemented as a method, process, apparatus, system, or article of manufacture such as a non-transitory computer-readable medium or device. For illustration purposes, the present framework may be described in the context of distributed ledgers being publicly available, or at least available to untrusted third parties. One example as a modern use case is with blockchain-based systems. It should be appreciated, however, that the present framework may also be applied in other settings where sensitive or confidential information may need to pass by or through hands of untrusted third parties, and that this technology is in no way limited to distributed ledgers or blockchain uses.

Computer system 600 may be a client or server, accessing or hosting any applications and/or data through any delivery paradigm, including but not limited to remote or distributed cloud computing solutions; local or on-premises software (e.g., “on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), database as a service (DBaaS), etc.); and/or a hybrid model including any combination of the foregoing examples or other services or delivery paradigms.

Any applicable data structures, file formats, and schemas may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

Any pertinent data, files, and/or databases may be stored, retrieved, accessed, and/or transmitted in human-readable formats such as numeric, textual, graphic, or multimedia formats, further including various types of markup language, among other possible formats. Alternatively or in combination with the above formats, the data, files, and/or databases may be stored, retrieved, accessed, and/or transmitted in binary, encoded, compressed, and/or encrypted formats, or any other machine-readable formats.

Interfacing or interconnection among various systems and layers may employ any number of mechanisms, such as any number of protocols, programmatic frameworks, floorplans, or application programming interfaces (API), including but not limited to Document Object Model (DOM), Discovery Service (DS), NSUserDefaults, Web Services Description Language (WSDL), Message Exchange Pattern (MEP), Web Distributed Data Exchange (WDDX), Web Hypertext Application Technology Working Group (WHATWG) HTML 5 Web Messaging, Representational State Transfer (REST or RESTful web services), Extensible User Interface Protocol (XUP), Simple Object Access Protocol (SOAP), XML Schema Definition (XSD), XML Remote Procedure Call (XML-RPC), or any other mechanisms, open or proprietary, that may achieve similar functionality and results.

Such interfacing or interconnection may also make use of uniform resource identifiers (URI), which may further include uniform resource locators (URL) or uniform resource names (URN). Other forms of uniform and/or unique identifiers, locators, or names may be used, either exclusively or in combination with forms such as those set forth above.

Any of the above protocols or APIs may interface with or be implemented in any programming language, procedural, functional, or object-oriented, and may be compiled or interpreted. Non-limiting examples include C, C++, C#, Objective-C, Java, Scala, Clojure, Elixir, Swift, Go, Perl, PUP, Python, Ruby, JavaScript, WebAssembly, or virtually any other language, with any other libraries or schemas, in any kind of framework, runtime environment, virtual machine, interpreter, stack, engine, or similar mechanism, including but not limited to Node.js, V8, Knockout, jQuery, Dojo, Dijit, OpenUI5, AngularJS, Express.js, Backbone.js, Ember.js, DHTMLX, Vue, React, Electron, and so on, among many other non-limiting examples.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

### Example Applications

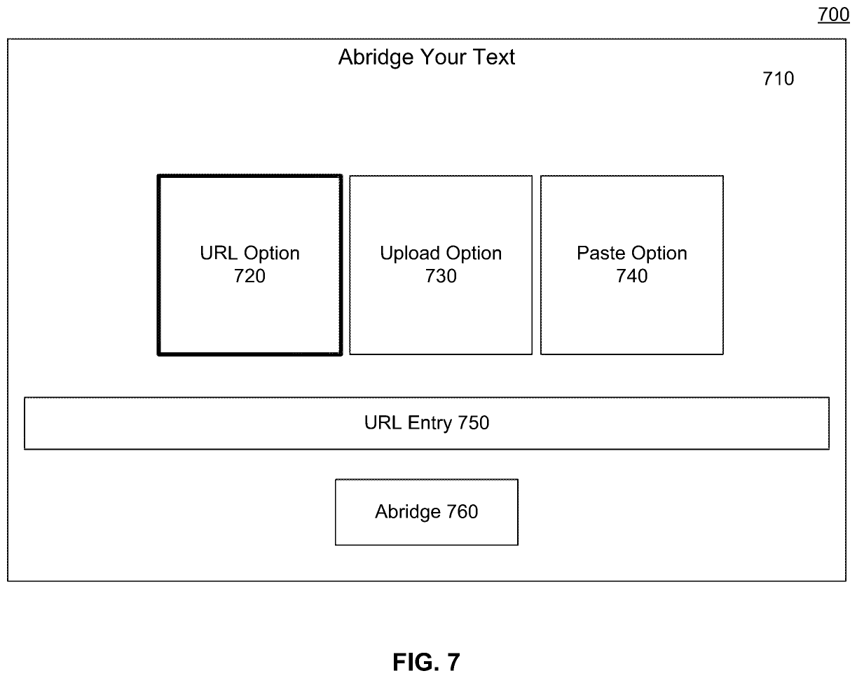

In some embodiments, abridging of text is accomplished via an application or webpage, such as those depicted below in FIGS. 7-10. For example, computer system 600 can run the application or the web browser with the webpage, either of which provide tools for abridging a text, as described in various embodiments herein. As other non-limiting examples, the application or the webpage can also be run on a tablet, smart phone, e-reader device 530, laptop, or other electronic device or system. Various embodiments of the application or the webpage can provide for taking an original text and abridging it into two or more other texts, as described in more detail above.

FIG. 7 illustrates a block diagram of an application 700 for abridging text from a URL, according to some embodiments. Application 700 runs on a computer system 600, or another electronic device, such as a tablet, smart phone, e-reader device, or laptop. In some embodiments, application 700 is a part of a larger application, such as a screen in the larger application, or a page of a webpage or website.

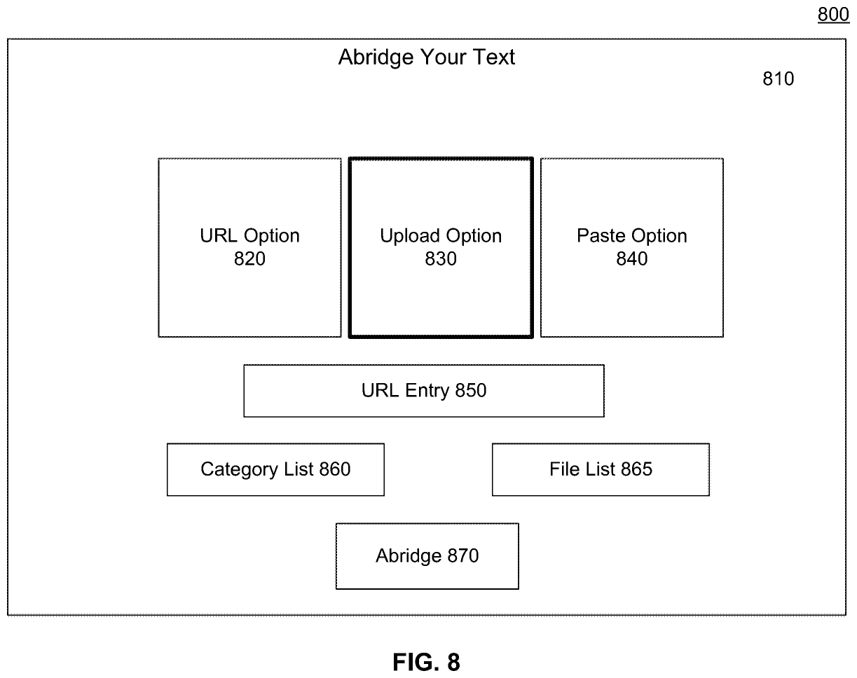

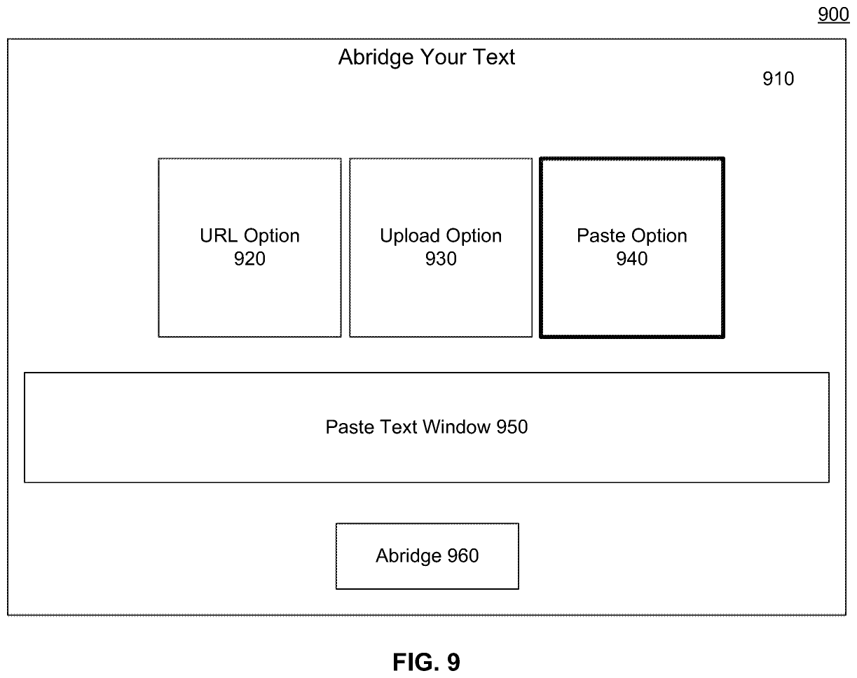

Application 700 allows a user to enter a URL and abridge an original text located at the URL. In some embodiments, application 700 has an interface 710 that provides the tools for abridging the original text. Buttons URL option 720, upload option 730, and paste option 740 are included for selecting how to input the original text. Upload option 730 and paste option 740 can be selected to change to a different interface, such as a different webpage or screen. For example, upload option 730 can access application 800 (see FIG. 8) and paste option 740 can access application 900 (see FIG. 9).

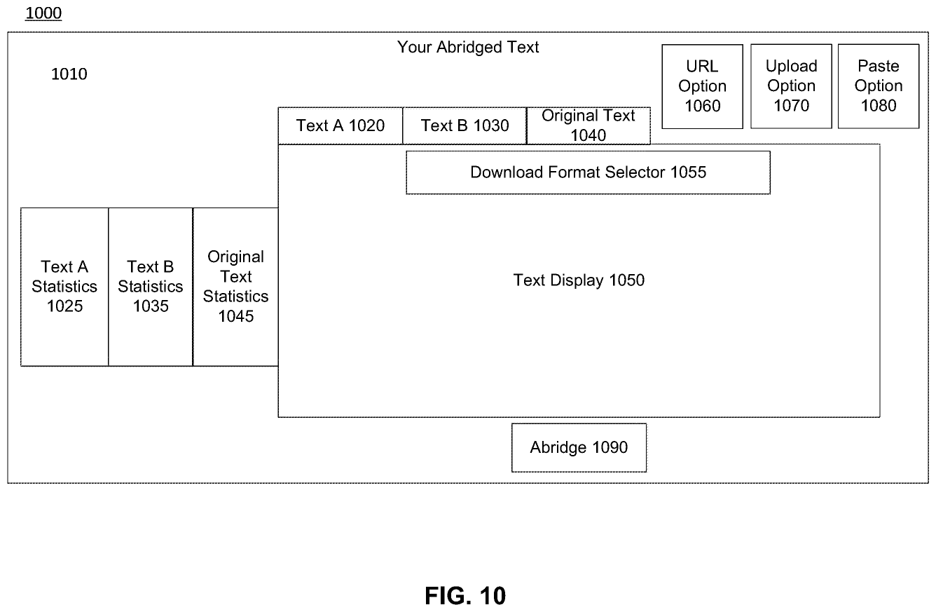

In interface 710, URL option 720 is highlighted, as indicated by the heavier outline of the button. URL entry 750 allows a user to enter a URL of the original text. The user can select the button abridge 760 to abridge the text at the URL. For example, in some embodiments, selecting or activating abridge 760 causes application 700 to apply method 200 to the original texted located at the URL. In some embodiments, after applying method 200, abridge 760 accesses application 1000, described below in FIG. 10, to display the abridged text.

FIG. 8 illustrates a block diagram of an application 800 for abridging text from a file, according to some embodiments. Application 800 runs on a computer system 600, or another electronic device, such as a tablet, smart phone, e-reader device, or laptop. In some embodiments, application 800 is a part of a larger application, such as a screen in the larger application, or a page of a webpage or website.

Application 800 allows a user to upload or select a file and abridge an original text in the file. In some embodiments, application 800 is a part of a larger application, such as a screen in the larger application, or a page of a webpage or website. In some embodiments, application 800 has an interface 810 that provides the tools for abridging the original text. Buttons URL option 820, upload option 830, and paste option 840 are included for selecting how to input the original text. URL option 820 and paste option 840 can be selected to change to a different interface, such as a different webpage or screen. For example, URL option 820 can access application 700 (see FIG. 7) and paste option 840 can access application 900 (see FIG. 9).

In interface 810, upload option 830 is highlighted, as indicated by the heavier outline of the button. Choose file 850 allows a user to select a file on a device, such as the tablet, smart phone, computer system 600, laptop, or e-reader device that application 800 runs on. The selected file contains the original text.

In some embodiments, interface 810 includes a category list 860 and file list 865. File list 865 contains a list of files that are selectable as the original text. Category list 860 includes a list of category topics for the file list. In some embodiments, when a category is selected from category list 860, the listing of files in file list 865 is reduced to those files that correspond to the selected category.

The user can select abridge 870 to abridge the text in the selected file, either from choose file 850 or file list 865. For example, in some embodiments, selecting or activating abridge 870 causes application 800 to apply method 200 to the original texted located in the file selected by choose file 850. In some embodiments, after applying method 200, abridge 870 accesses application 1000, described below in FIG. 10, to display the abridged text.

FIG. 9 illustrates a block diagram of an application 900 for abridging copied text, according to some embodiments. Application 900 runs on a computer system 600, or another electronic device, such as a tablet, smart phone, e-reader device, or laptop. In some embodiments, application 900 is a part of a larger application, such as a screen in the larger application, or a page of a webpage or website.

Application 900 allows a user to abridge an original text pasted into a window. In some embodiments, application 900 has an interface 910 that provides the tools for abridging the original text. Buttons URL option 920, upload option 930, and paste option 940 are included for selecting how to input the original text. Upload option 930 and URL option 920 can be selected to change to a different interface, such as a different webpage or screen. For example, upload option 930 can access application 700 (see FIG. 7) and upload option 930 can access application 800 (see FIG. 8).

In interface 910, paste option 940 is highlighted, as indicated by the heavier outline of the button. Paste text window 950 allows a user to paste the original text. Paste text window 950 can be an interface object into which text is entered or pasted. For example, a user can copy text from a different program or interface, such as another website, a document with text, or an application or software program and paste the copied text into paste text window 950. The user can select the button abridge 960 to abridge the text pasted into paste text window 950. For example, in some embodiments, selecting or activating abridge 960 causes application 900 to apply method 200 to the original texted pasted into paste text window 950. In some embodiments, after applying method 200, abridge 960 accesses application 1000, described below in FIG. 10, to display the abridged text.

FIG. 10 illustrates a block diagram of an application 1000 for viewing and reading abridged text, according to some embodiments. Application 1000 runs on a computer system 600, or another electronic device, such as a tablet, smart phone, e-reader device, or laptop. In some embodiments, application 1000 is a part of a larger application, such as a screen in the larger application, or a page of a webpage or website.

Application 1000 allows a user to view and read an abridged original text. In some embodiments, application 1000 has an interface 1010 that provides tools for viewing, reading and interacting with the abridged original text. In some embodiments, interface 1010 includes download format selector 1055, which allows a user to download an abridged text in a selected format. In some embodiments, interface 1010 includes statistics of the abridged text, such as text A statistics 1025, text B statistics 1035, and original text statistics 1045. In some embodiments, interface 1010 includes tools for abridging an additional text, such as URL option 1060, upload option 1070, paste option 1080, and abridge 1090.

Interface 1010 displays text in text display 1050. A user can select to display the original text by selecting the tab or button original text 1040. The user can select one or more other tabs that select different versions of the abridged text. In some embodiments, the original text is abridged into two versions and the tabs or buttons are text A 1020 and text B 1030, which both allow a user to access the corresponding text by selecting or activating them. In some embodiments, text A 1020 is text X and text B 1030 is text C, as described above for some embodiments in this disclosure.

Download format selector 1055 allows a user to download text, such as the text displayed in text display 1050 or one of the texts available in the different tabs, such as the abridged texts in text A 1020 and text B 1030 or original text 1040. As an example, download format selector 1055 can have pulldown menus or buttons for selecting different formats, such as different word processing formats, pdf format, text document format, or other formats for saving text documents. In some embodiments, download format selector 1055 downloads the text being displayed in text display 1050. In some embodiments, download format selector 1055 includes buttons or menus for selecting the original text or one of the abridged versions for download. In some embodiments, download format selector 1055 includes buttons for selecting font type, font size, font color, background color, and line spacing in the text to be downloaded. In some embodiments, text display 1050 displays how the text will look in the downloaded format based on the selected font type, font size, font color, background color, and line spacing.

In some embodiments, interface 1010 includes displays of statistics regarding the abridged and original versions of the text. Text A statistics 1025 displays the statistics of text A 1020, text B statistics 1035 displays the statistics of text B 1030, and original text statistics 1045 displays the statistics of original text 1040. Statistics in this context can include different metrics that describe the different texts and allow for comparison. For example, statistics include number of words in a text, a percentage that the text is of the original text, an estimated reading time for the text (such as number of minutes to read the text), a percentage that the estimated reading time is of the original text, a comprehension strength, and words morphological quality. In some embodiments, the comprehension strength is a number and/or word label describing the comprehensibility of the text as defined by the Dale-Chall readability formula described above in this disclosure. In some embodiments, a word's morphological quality is a number and/or word label that gauges the quantities/percentages of different classes of words making-up the text other than just “word meaning” that contribute significantly to reading comprehension. For example, a word's morphological quality can vary for: 1) unique words—words appearing only once in the text, 2) Stop words—natural language words, very commonly used (making-up about 30% of every text), which have very little meaning as for example: “the”, “a”, “and”, “but”, “how”, “or” and “what”, 3) short words—words entailing up to 3 letters and, 4) long words—words longer than 7 letters. Comparing the morphological quality of the words in the text before and after abridging provides a comparison of the abridged text to the original text. In some embodiments, this comparison is provided for the text B 1030 when it is text C as described above.

In some embodiments, interface 1010 includes buttons for abridging another text. For example, URL option 1060, upload option 1070, and paste option 1080 can be selected to upload a different text using different abridging options.

In some embodiments, each of the buttons accesses the application or screen corresponding to the selection. For example, URL option 1060 accesses or navigates to application 700, upload option 1070 accesses or navigates to application 800, and paste option 1080 accesses or navigates to application 900.

In some embodiments, each of the buttons accesses an overlay over the top of interface 1010 that corresponds to the selection. For example, URL option 1060 can access an overlay that includes buttons URL entry 750 and abridge 760, upload option 1070 can access an overlay that includes choose file 850, category list 860, file list 865, and abridge 870, and paste option 1080 can access an overlay that includes buttons paste text window 950 and abridge 960.

In some embodiments, interface 1010 includes abridge 1090, which can be activated to access a home page of an application or a default application selected from applications 700, 800, or 900.

In some embodiments, an application for abridging text can be made up of or include applications 700, 800, 900, and 1000 as a system for providing multiple means of providing text for abridgement according to the text abridging methods described herein, such as method 200. The abridged text can be viewed, read and interacted with, and downloaded in application 1000.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different from those described herein.

References herein to “one embodiment,” “an embodiment,” “an example embodiment,” “some embodiments,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method for abridging an original text for display on a mobile device, the method comprising:
forming letter matching groups between each pair of adjacent sentences in the original text;
determining whether the letter matching groups satisfy at least one alphabetical matching rule;
in response to a first sentence from the original text belonging only to respective letter matching groups from the letter matching groups which satisfy at least one alphabetical matching rule, adding the first sentence to a first abridged text;
in response to a second sentence from the original text belonging to at least one respective letter group from the letter matching groups which fails to satisfy each alphabetical matching rules, adding the second sentence to a second abridged text;
providing a shorter of the first abridged text or the second abridged text to the mobile device.

2. The method of claim 1, further comprising:
forming second letter matching groups between each pair of adjacent sentences in the first abridged text;
determining whether the second letter matching groups satisfy at least one alphabetical matching rule;
in response to a third sentence from the first abridged text belonging to at least one respective letter group from the second letter matching groups which fails to satisfy each of the alphabetical matching rules, moving the third sentence to the second abridged text.
repeating the steps of forming second letter matching groups, determining whether the second letter matching groups satisfy alphabetical matching rules, and moving the third sentences until all of the sentences in the first abridged text satisfy the alphabetical matching rules;
in response to the first abridged text failing to contain a beginning sentence, an end sentence, or both from the original text, adding the beginning sentence, the end sentence, or both to the first abridged text;
in response to the second abridged text failing to contain the beginning sentence, the end sentence, or both from the original text, adding the beginning sentence, the end sentence, or both to the second abridged text.

3. The method of claim 2, further comprising changing a visual layout of one or more abridged texts by inducing sensorial stimuli into one or more letters in the first abridged text and the second abridged text, based on a position of one or more letters in the first abridged text and the second abridged text.

4. The method of claim 3, wherein changing the visual layout of the one or more abridged texts by inducing the sensorial stimuli comprises one or more of changing a color of the one or more letters, flickering of the one or more letters, and changing a font tilt of the one or more letters.

5. The method of claim 4, wherein changing the visual layout of one or more abridged texts by inducing the sensorial stimuli is performed such that one or more of the sensorial stimuli are induced beginning at a first time and ending at a second time, the first time and the second time based on a regional time in a location where the first abridged text or the second abridged text are being displayed on the mobile device.

6. A method for separating a first group of symbol arrays into a second group of symbol arrays and third group of symbol arrays, wherein the separation does not alter the original serial order position of symbols in the first group of symbol arrays, the second group of symbol arrays, or the third group of symbol arrays, the method comprising:
identifying contiguous symbol arrays from among the symbols of the first group of symbol arrays and assign to them an ordinal position within the first group of symbol arrays,
identifying ordinal positions of selected symbols within the contiguous symbol arrays,
separating symbol arrays from the first group of symbol arrays based on predefined rules concerning the ordinal positions of selected symbols, the separating placing respective symbol arrays which are correlated into a separate second group of symbol arrays and the respective symbol arrays which are partially correlated or non-correlated into a separate third group of symbols arrays; and
repeatedly separating correlated symbol arrays from the separate second group of symbol arrays into the separate third group of symbols arrays until the numerical relationship between a number of symbol arrays of the separate second group of symbol arrays and the separate third group of symbol arrays reaches a lowest numerical value.

7. The method of claim 6, wherein symbols are one or more of letters, numbers, and geometrical forms.

8. The method of claim 6, wherein the symbol arrays are arrays of letters forming a word, and wherein arrays of words form the sentences of a first text in a preselected language.

9. The method of claim 6, wherein information from any group of symbol arrays is acquired by a sensory-perceptual channel of a subject.

10. The method of claim 8, wherein identifying the symbol arrays discriminates a first ordinal position to an Nth ordinal position of sentences within a first text and words within a sentence in the first text.

11. The method of claim 10, wherein a first text comprises at least seven sentences.

12. The method of claim 11, wherein identifying the selected ordinal positions of symbols comprises identifying selected ordinal positions of the letters based on predefined matching rules denoting that contiguous sentences are correlated or not correlated, wherein the matching rules are applied to: a beginning letter, an end letter or both from one or two words at a sentence beginning, a sentence end, or both.

13. The method of claim 12, further comprising determining correlation between the contiguous sentences is based on predefined matching rules between selected letters from four consecutive coupling words selected from a first two consecutive words at a first beginning of a first sentence follow second two consecutive words at an end of a previous sentence adjacent to the first beginning of a first sentence, or a third two consecutive words at a second end of a second sentence followed by a fourth two consecutive words at a second beginning of a following third sentence adjacent to the second sentence, wherein three Letter Matching Groups of four letters each are obtained from the four consecutive coupling words.

14. The method of claim 12, further comprising determining correlation between the contiguous sentences based on predefined matching rules between selected letters of a Letter Matching Group formed from a first four letters at a beginning of a beginning four words of four consecutive sentences in a Vertical Sentence-Beginning Mode, or by a second four letters at an end of a last four words of the four consecutive sentences in a Vertical Sentence-End Mode.

15. The method of claim 13 further comprising determining correlation between each set of contiguous sentences in the first text.

16. The method of claim 14, further comprising determining correlation between each set of four contiguous sentences in the first text.

17. The method of claim 15, wherein the contiguous sentences are correlated if a respective first pair of letters from a Letter Matching Group in the three Letter Matching Groups satisfy a matching rule, wherein the respective first pair of letters are two consecutive letters of the Letter Matching Group, a beginning letter and a third letter in the Letter Matching Group, or a second letter and a last letter in the Letter Matching Group.

18. The method of claim 17, wherein the predefined matching rules comprise:
the first pair of letters are a same letter; and
the first pair of letters match a bigram from a predefined first list of bigrams based on a language of the first text.

19. The method of claim 16, wherein the contiguous sentences are correlated if the selected letters from the Letter Matching Group satisfy a matching rule, wherein the selected letters are two consecutive letters the Letter Matching Group, a beginning letter and a third letter in the Letter Matching Group, or a second letter and a last letter in the Letter Matching Group.

20. The method of claim 19, wherein the predefined matching rules comprise:
the first pair of letters are a same letter; and
the first pair of letters match a bigram from a predefined first list of bigrams based on a language of the first text.

21. The method of claim 6, further comprising inducing sensorial stimuli in a set of letters from the second set of symbol arrays and the third set of symbol arrays, wherein the sensorial stimuli comprise changing a color in the set of letters, flickering the set of letters, changing a font tilt of the set of letters, or causing a change in the set of letters at a regional time where the second set of symbol arrays or the third set of symbol arrays are being read.

22. The method of claim 12, wherein a beginning sentence of the first text, an a ending sentence of the first text, or both are added to the second set of symbol arrays or the third set of symbol arrays in response to the beginning sentence, the ending sentence, or both, respectively, being missing from the second set of the symbol arrays or the third set of symbol arrays.

23. The method of claim 21, wherein the set of letters comprise bigrams of a list of bigrams and trigrams of a list of trigrams.

24. The method of claim 23, wherein the inducing of the sensorial stimuli in each bigram occurs in response to one of:
a first respective beginning letter in the bigram being a second respective beginning letter in a respective beginning word in a first respective sentence;
a first respective ending letter in the bigram being a first respective ending letter of a respective ending word in the first respective sentence;
a third respective beginning letter of the bigram being a fourth respective beginning letter of a first respective word and a fifth respective letter in the bigram is a second respective ending letter of a respective preceding word preceding the first respective word in a second respective sentence;
a pair of letters of the bigram are two contiguous letters in a third respective word in a third respective sentence; or
the pair of letters of the bigram are a third respective ending letter of a fourth respective word and a fifth respective beginning letter of an adjacent respective word in a fourth respective sentence.

25. The method of claim 24, wherein the inducing of the sensorial stimuli in each trigram occurs in response to one of:
the trigram comprising a first respective beginning two letters being a second respective beginning two letters in a first respective sentence and a first respective ending letter in the trigram being a second respective ending letter in a respective ending word of the first respective sentence;
the trigram comprising a first respective beginning letter of the trigram is a second respective beginning letter in a first respective beginning word in a second respective sentence and a first respective ending two letters are a second respective ending two letters in the second respective sentence;
the trigram comprising a first set of contiguous letters beginning from a first end of a respective ending word and a third respective beginning of a second respective beginning word in contiguous sentences;
the trigram comprising three consecutive letters beginning from a second end of a first respective word and ending at a fourth respective beginning of a first contiguous word;
or the trigram comprises three contiguous letters of a second respective word comprised of at least four letters.

26. The method of claim 23, wherein the bigrams and trigrams are from words in the first text that are not nouns or proper names.

27. The method of claim 21, wherein the sensorial stimuli comprise first sensorial stimuli and second sensorial stimuli, wherein the first sensorial stimuli are induced during a first predefined pre-attentive time interval and the second sensorial stimuli are induced during a second pre-defined pre-attentive time intervals.

28. The method of claim 22, wherein inducing the sensorial stimuli further comprises generating an audio stream, wherein the audio stream is modulated using one or more of changes in a pitch, an amplitude, or frequency modulation, wherein the audio stream comprises the second set of symbol arrays or the third set of symbol arrays and is varied based on a region time where the audio stream is being output.
